(19) United States
(12) Patent Application Publication
(10) Pub. No.: US 2017/0349458 A1
(43) Pub. Date: Dec. 7, 2017

(54) Membraneless Water Electrolysis Method for Significantly Improving Electrolysis Efficiency

(71) Applicants: Minxiong LUO, Shenzhen (CN); Ming LI, Shenzhen (CN)

(72) Inventors: Minxiong LUO, Shenzhen (CN); Ming LI, Shenzhen (CN)

(21) Appl. No.: 15/686,923

(22) Filed: Aug. 25, 2017

Related U.S. Application Data
(63) Continuation of application No. PCT/CN2016/000101, filed on Feb. 24, 2016.

(30) Foreign Application Priority Data
Feb. 26, 2015 (CN) 201510088613.X

(51) Int. Cl. C02F 1/461; C02F 103/02

(52) U.S. Cl. CPC C02F 1/4618; C02F 1/46109; C02F 2103/026; C02F 2001/46138; C02F 2201/4618; C02F 2001/46171

(57) ABSTRACT

The present disclosure discloses a novel membrane-less water electrolysis method for obviously increasing electrolysis efficiency. The method focuses on enabling more impurities in water to be electrolyzed to produce many electrons and conductive ions, and creating good conditions to increase water electrolysis efficiency. A spacing of a gap reserved between a positive electrode and a negative electrode is designed according to a reasonable minimization principle, and the gap is less than 5 mm and more than 0 mm, thereby benefiting enhancement of electrolysis between the impurities and the water molecules in the water; and in a water electrolysis process, the water can smoothly flow in the gap between the positive and the negative electrodes, and a probability and quantities of the impurities and the water molecules electrolyzed by the positive and the negative electrodes are increased, thereby increasing the electrolysis efficiency of the water.

### TECHNICAL FIELD

The present invention relates to a novel membrane-less water electrolysis method for obviously increasing electrolysis efficiency, and belongs to the technical field of isolating-membrane-less water electrolysis.

### BACKGROUND

More than 80 years ago, a water electrolysis machine has been invented in Japan, and human beings start a practice of drinking electrolyzed water to treat diseases and maintain health. The electrolyzed water is recognized as water with an actual effect on human health by Ministry of Health and Welfare (Japan's Health Ministry) in the 1960s, and the water electrolysis machine is approved to serve as medical equipment for production and selling. The water electrolysis machine is also formally approved by Ministry of Public Health of China in the 1990s to serve as the medical equipment for production and selling. Today, China and Japan become main countries for production and selling the water electrolysis machine in the world. A variety of water electrolysis machines sweep the world. Health of hundreds of millions of people is benefited from drinking of the electrolyzed water. The water electrolysis technology is constantly updated and developed. The present invention belongs to an innovative high-efficiency water electrolysis method in the technical field of water electrolysis.

Water electrolysis efficiency generally can be defined as a ratio of a certain representative index (such as an ORP negative value or a hydrogen content value of electrolyzed reduced water) in the prepared electrolyzed water and consumed power under conditions that a certain amount of water is electrolyzed and electrolysis is performed for a certain time. At present, a common water electrolysis method and apparatus in a market are mainly classified into two kinds, i.e., an isolating membrane type and an isolating membrane-less type. An existing water electrolysis machine adopts an isolating membrane technology. Although the technology is constantly upgraded, the water electrolysis machine still cannot really overcome defects as follows: electrolysis efficiency of the water is extremely low; the machine must be connected with running water and cannot be carried; electrolyzed acidic water and electrolyzed alkaline water of a normal temperature must be respectively output from two areas isolated by the isolating membrane, and waste of the water is easily caused; the water is often unsuitable to be drunk due to the water temperature; main functional indexes are obviously decreased and even disappear when the electrolyzed water is heated to reach a too high temperature, and the like. Xiao Zhibang from China invents an isolating-membrane-less water electrolysis method and apparatus in 2008, and creates a new approach for overcoming the defects of the above isolating membrane water electrolysis technology. An applicant discovers in a process of researching the isolating-membrane-less water electrolysis technology that: the greatest common problem of the water electrolysis technology is extremely low electrolysis efficiency. For example, when approximately a kilowatt of power is consumed by the water electrolysis machine, generally small-flow direct-drinking electrolyzed reduced water with a hydrogen content of only hundreds of ppb or a fraction of ppm (1 ppm=1000 ppb) is obtained. The power consumed by the existing isolating-membrane-less water electrolysis technology is much lower than that consumed by the isolating-membrane water electrolysis technology and is only several watts. However, efficiency is still not high, and the hydrogen content of the electrolyzed water in the isolating-membrane-less technology is generally lower than that of the water electrolysis machine adopting the isolating-membrane technology. For purified water, distilled water and other water with extremely low conductivity, regardless of the isolating-membrane electrolysis technology or the isolating-membrane-less electrolysis technology, the electrolysis efficiency is lower, and it can be approximately considered that the water is not effectively electrolyzed. These problems seriously restrict actual popularization and application of the water electrolysis technology. In order to solve the problems, the applicant conducts long-term research and exploration and finally makes a critical breakthrough in two aspects, i.e. theory and practice.

### SUMMARY

The present invention proposes a novel membrane-less water electrolysis method for obviously increasing electrolysis efficiency, and belongs to the technical field of isolating-membrane-less water electrolysis.

The novel membrane-less water electrolysis method for obviously increasing electrolysis efficiency in the present invention is based on a deep understanding of the applicant for great defects in a water electrolysis principle of a traditional water electrolysis machine, and a novel water electrolysis principle found subsequently by the applicant. The water electrolysis principle of the traditional water electrolysis machine indicates that: an ion H+ in a negative electrode water area and an electron from a positive electrode water area are combined into H, and the H is combined with +− to synthesize H2 to be released from the water, so that H in an alkaline water area is decreased, a content of OH is relatively high, then the negative electrode water area is alkaline, an oxidation reduction potential (ORP) of the alkaline water is a negative value, and the alkaline water becomes special drinking water beneficial to human health. On the contrary, since electrons are lost in the positive electrode water area, more H+ exist in the positive electrode water area, and then the positive electrode water is acidic and can be used for sterilizing and disinfecting. The principle which has been widespread has two major defects as follows: firstly, a real source of lots of electrons needed in a process of forming the alkaline water in the negative electrode area is misunderstood. In the principle, a direction in which the electrons move continuously from the positive electrode area to the negative electrode area is reversed to a direction of an electric field acting force of an electrolysis electrode. The electrons hindered by the electric field force and capable penetrating through the isolating membrane to drift or diffuse into the negative electrode area are limited. The electrons are not the real source of electrons needed for forming lots of hydrogen in the negative electrode area, and the defect in the principle hinders human discovery of the real electron source in recent 100 years. The second great defect is a phenomenon that the alkaline water in the negative electrode area has a high key index of the reduced water, that is, a high oxidation reduction potential (ORP) negative value and a high hydrogen content (H, H, H−) cannot be explained, and key conditions that formation of the high ORP negative value in the negative electrode area and the H2, particularly negative hydrogen or activated hydrogen needs a considerable quantity of active electrons are completely neglected. It can be seen from the above that, the lots of free electrons needed in the negative electrode area impossibly come from electrolysis of water molecules in the positive electrode area as described in the principle, but certainly have another source. The applicant intensively researches a phenomenon that the existing water electrolysis machine and isolating-membrane-less electrolysis apparatus cannot effectively electrolyze purified water and distilled water, and gains critical revelations as follows: impurities in the water are the real source of a majority of electrons. A great deal of electrons needed by electrolytic current, formation of the key indexes of the reduced water, such as the ORP negative value and the negative hydrogen H− and the like in the electrolysis process mainly come from electrolysis of the impurities in the water. The purified water contains very few impurities, and active electrons which can be produced by the existing water electrolysis method are correspondingly few, so the electrolysis current is small under a certain electrolysis voltage, and since a structural cause of the electrolysis electrode restricts the indexes of the electrolyzed water (such as the ORP negative value and the hydrogen content index), the electrolysis efficiency is low. A water electrolysis machine, used for electrolyzing flowing running water, which adopts power of hundreds of watts and high current of more than ten amperes cannot reach high water electrolysis indexes. Even if a pH value reaches 9.5 or higher when the machine is operated at the highest gear, the ORP negative value is still not high, and the hydrogen content index is still less than 1000 ppb. In addition, because the isolating-membrane-less water electrolysis technology is not high enough in electrolysis efficiency, and a water electrolysis index level is far from a basic requirement of practicality, a practical product for making the electrolyzed water by performing one-time electrolysis on the running water does not come out. The applicant researches to recognize that: in order to break through an existing technical bottleneck of the water electrolysis technology, a novel water electrolysis principle should be established, and a novel water electrolysis method and process should be created according to the novel water electrolysis principle.

The novel water electrolysis principle and an innovative water electrolysis process method thereof discovered and invented by the applicant are based on six new discoveries above, and are summarized as follows by taking a method for making the reduced water through electrolysis as an example:

A first new discovery of the applicant is as follows: in a water electrolysis process, in order to increase water electrolysis efficiency, a primary task is to electrolyze impurities in water (also called an “electrolysis effect of impurities in water”, and called “impurity electrolysis effect” for short). Free electrons and impurity particles contributing to increasing water electrolysis indexes are produced, certain electrolysis current is formed, and electric energy is transferred to hydrogen and oxygen atoms or complex ion radicals in the water molecules so as to produce activity which can be called “active performance” or “activity”. When the activity is high enough, the activity goes in separate ways to enable the water molecules to be decomposed into hydrogen and oxygen ions or hydroxide ions, and the process can be called a “water molecule electrolysis effect”, i.e. a “water electrolysis effect” for short. The traditional water electrolysis technology attaches importance to an effect of conductivity of the water for maintaining the electrolysis current, but only pays attention to an effect of the current therein on electrolysis of the water molecules, so the principle of the technology is limited to a chemical equilibrium equation of the whole electrolysis process after the water molecules are electrolyzed, a phenomenon that the electrons and impurity particles produced by the “impurity electrolysis effect” in the electrolysis process participate in the water electrolysis process is completely neglected, and important significances for increasing the water electrolysis indexes and electrolysis efficiency are completely neglected. Therefore, a design solution of the traditional water electrolysis machine is a design solution which singly focuses on the electrolysis of the water molecules without considering the electrolysis of the impurities at all. As a result, even if the electrolysis current is high and the power is high, the indexes of the electrolyzed reduced water are high, and the electrolysis efficiency is low.

A second new discovery of the applicant is as follows: dual significances of the active electrons produced by the “impurity electrolysis effect” for increasing the electrolysis efficiency are disclosed, and the active electrons not only can increase the electrolysis current, but also have another important significance for making the reduced water through the electrolysis, that is, satisfy the needs of certain water electrolysis indexes, such as the ORP negative value (i.e. a negative oxidation reduction potential) of the electrolyzed reduced water and a corresponding hydrogen content (i.e. a negative hydrogen content), for the electrons. Since production of the ORP negative value and the corresponding hydrogen content needs participation of a certain quantity of the active electrons, sufficient active electrons contribute to increasing the indexes of the electrolyzed reduced water; otherwise, if the active electrons are insufficient, numerical values of the indexes of the electrolyzed reduced water will be obviously influenced, thereby reducing the water electrolysis efficiency. Actually, the magnitude of the ORP negative value is just reflection and measurement of sufficient or insufficient active electrons in the water. For another example, the impurity electrolysis effect has extremely important significances on indexes such as the hydrogen made by the water electrolysis and the like. It can be seen that the “impurity electrolysis effect” should be intensified as much as possible to produce more active electrons, while creating opportunities that more impurities are electrolyzed and are repeatedly electrolyzed is an effective method for intensifying the “impurity electrolysis effect” to produce more active electrons.

A third new discovery of the applicant is as follows: a small gap (particularly a small gap less than 1 mm) between the positive and the negative electrodes has a particularly obvious effect for intensifying the “impurity electrolysis effect”. Although the previous isolating-membrane-less water electrolysis technology mentions a design consideration that the gap between the positive and the negative electrodes is more than zero and less than 3 mm, a practical significance of the small gap is neither known nor clearly explained, and the technology is not associated with the “impurity electrolysis effect”. Therefore, a design of a corresponding matched process flow is not adopted, and the water electrolysis efficiency is not obviously increased.

A fourth very important new discovery of the applicant is as follows: more opportunities and conditions for combining the active electrons and the active hydrogen H into the negative hydrogen are created, so that efficiency of making the reduced water through electrolysis can be obviously increased. The applicant verifies through experiments that: the active electrons with a high content and the active hydrogen with a high content are easily combined to become a negative hydrogen ion H− in a small gap between the positive and the negative electrodes of a certain structure, and the H− is produced by attracting an electron by H with weak positive electricity (i.e., a micro order of magnitude) formed in the electrolysis process. Bai Tian, a famous Japanese water electrolysis expert, explains as follows: metal particles contribute to combining the active electrons and the H in the electrolysis and then represent physical properties of hydrogen with a negative potential. The hydrogen was called “active hydrogen” by Bai Tian. The applicant thinks that the “active hydrogen” can be understood as hydrogen with the active electrons or the negative hydrogen H−. The applicant researches and verifies that: an increase of the negative hydrogen content in the water has dual significances for increasing the negative potential and the hydrogen content, and therefore is of great importance for increasing reduction indexes of the electrolyzed water.

However, the applicant has a fifth new discovery after thorough exploration. An experiment shows that when a small gap between the positive and the negative electrodes is small to a certain value, the electrolysis efficiency is not high but is decreased under a certain electrolysis electrode structure and mounting process conditions thereof. In view of this, the study finds that: in order to intensify the “impurity electrolysis effect”, the water needs to have certain liquidity in the gap between the positive and the negative electrodes in the electrolysis process. If the liquidity of the water in the electrolysis gap is poor, electrons and ions produced by electrolyzing the impurities and the water molecules cannot be diffused out, water and impurities outside the gap cannot smoothly flow into the gap, and the electrolysis effect and efficiency will be obviously decreased, so that the electrolytic reduction indexes of the water are low; and if the liquidity of the water in the electrolysis gap is good, the water and the impurities will continuously flow into the gap, and the water is constantly changed for electrolyzing, so that the water and the impurities in the gap maintain excellent electrolysis effects and high electrolysis efficiency, and many impurities and water molecules are repeatedly electrolyzed, thereby increasing the electrolyzed water indexes, which is of great importance for increasing electrolysis efficiency of natural static state water. Since the water is electrolyzed by the electrode gap to produce hydrogen and oxygen, gases ascend to drive the water in the gap to flow, bubbles smoothly ascend to smoothly flow with the water, and many impurities and water molecules can be promoted to be repeatedly electrolyzed, thereby intensifying the “impurity electrolysis effect” and increasing the water electrolysis efficiency and electrolyzed water reduction indexes of the water.

A sixth new discovery of the applicant is as follows: for electrolysis of running water driven by an external force, such as running water, a design solution for reasonably increasing an area of the electrolysis gap in a certain space occupied by the electrode assembly contributes to enabling many impurities and water molecules in the water to be repeatedly electrolyzed, so that the water electrolysis efficiency and the electrolysis indexes can be increased. In addition, for a channel in which the electrolysis electrode assembly is mounted, with the adoption of a design that a water outlet channel (i.e. a water outlet) is properly narrower than a water inlet channel (i.e. a water inlet), flow velocity of the water flowing through the electrolysis electrode assembly can be reduced, thereby increasing time and opportunities for enabling the impurities and water molecules to be electrolyzed and increasing the water electrolysis indexes.

By virtue of comprehensive analysis of the above six new discoveries, the applicant proposes a novel water electrolysis principle as follows: a water electrolysis process firstly is a process for electrolyzing the impurities in the water to produce the active electrons and form current so as to convert electric energy into decomposition energy of the water molecules; and a basis of obtaining high electrolysis efficiency is to enable more water molecules to obtain high electric energy to be decomposed, however, additional important conditions are needed for obtaining the high electric energy because the electrolysis process is also a process of generating physical and chemical actions among various hydroxide ions and ion radicals produced by decomposing various ions (particularly the active electrons) released by the electrolyzed impurities and the water molecules. Firstly, if many impurities are electrolyzed, many electrons and ions are released from the impurities, a probability of combining with the hydroxide ions is high, the water electrolysis indexes may be high, and then the electrolysis efficiency is high; and secondly, if the conditions are created to make that the probability of combining the electrons and ions released by the electrolyzed impurities with the hydroxide ions is high, the water electrolysis indexes may be high, and then the electrolysis efficiency is high. For example, to obtain a high ORP negative value and a high hydrogen content (the two indexes are briefly called as “negative hydrogen” indexes by the applicant) in the electrolyzed reduced water, participation of more active electrons is needed. Therefore, the impurities in the water are electrolyzed to release more electrons and the probability of combining the electrons with the hydrogen ion is high, which are two important conditions for increasing the negative hydrogen indexes and the electrolysis efficiency.

Revelations of the novel water electrolysis principle of the applicant are as follows: a coordinated and considered systematic process method is adopted for increasing the efficiency of making the reduced water through electrolysis. The electrolysis of the impurities in the water needs to be intensified, and the probability of combining the electrons released by the electrolysis of the impurities with the hydrogen should be increased. The applicant finds through researches that: firstly, a distance between electrolysis gaps of the positive and the negative electrodes is properly decreased; secondly, an area of the electrolysis gaps of the positive and the negative electrodes is properly enlarged; and thirdly, liquidity of water flowing in and out of the gap between the positive and the negative electrodes is properly maintained in the water electrolysis process. When the three technical conditions are simultaneously considered and coordinated, effects of intensifying the electrolysis of the impurities and increasing the reduction indexes can be well considered simultaneously, thereby obviously increasing the water electrolysis efficiency. The present invention discloses a novel membrane-less water electrolysis method for obviously increasing electrolysis efficiency, wherein the water electrolysis method focuses on enabling more impurities in water to be electrolyzed to produce many electrons and conductive ions, and creating good conditions to increase water electrolysis efficiency while forming electrolytic current to enable more electric energy to be changed into water molecule decomposition energy. An electrolysis electrode assembly for realizing the present water electrolysis method has features as follows: a spacing of a gap reserved between a positive electrode and a negative electrode is designed according to a reasonable minimization principle, and the gap is less than 5 mm and more than 0 mm, thereby benefiting enhancement of electrolysis between the impurities and the water molecules in the water; an area of the gap between the positive and the negative electrodes is designed according to a reasonable maximization principle in a certain space occupied by the electrolysis electrode assembly, so that more impurities and water molecules in the water can be repeatedly electrolyzed in the electrode gap; and the electrolysis electrode assembly and mounting process conditions thereof have features as follows: in the water electrolysis process, the water can smoothly flow in the gap between the positive and the negative electrodes, so that the water electrolyzed in the electrode gap can be replaced, more impurities and water molecules are repeatedly electrolyzed by the positive and the negative electrodes, and a probability and quantities of the impurities and the water molecules electrolyzed by the positive and the negative electrodes are increased, thereby increasing the electrolysis efficiency of the water.

The novel water electrolysis principle and method discovered by the applicant disclose a true cause that the existing water electrolysis machine and water electrolysis apparatus cannot electrolyze the purified water, and propose an unprecedented innovative method for obviously increasing the electrolysis efficiency as follows: the traditional water electrolysis principle completely neglects that the electrolysis of the impurities in the water plays a fundamental and critical role in increasing the electrolysis efficiency, the designed water electrolysis machine and apparatus do not focus on the fundamental role in increasing water electrolysis indexes played by the electrolysis of the impurities in the water, and then defects that the electrolysis efficiency is low, the conductivity is low, the water cannot be electrolyzed and the like are inevitably generated. The principle defects of the water electrolysis machine (apparatus) mislead a design direction for solving the above low-efficiency problem: on one hand, for the water electrolysis machines of many brands adopting the isolating membrane technology, the running water needs to be purified for safety; in order to effectively electrolyze the water, generally a called “electrolysis accelerator” is added into the water to change the purified water into non-purified water, so that the water has a certain conductivity, and a certain electrolysis current is maintained to achieve an index requirement of the electrolyzed water, while the electrolysis efficiency of the water is still limited to the traditional electrolysis electrode system and process and cannot be obviously increased; on the other hand, for some water electrolysis apparatus adopting the isolating-membrane-less technology, certain substances are added into the purified water to produce a certain electrolysis current so as to reach a certain water electrolysis index, or some measures for adjusting the electrolysis electrode structure are taken to improve the electrolysis effect; for example, a small gap of 0-3 mm between the positive and the negative electrodes is mentioned in a literature. However, an understanding for the small gap is only limited to a level of known knowledge (such as Ohm's law and the like), i.e., the small gap between the positive and the negative electrodes and large electrode area can reduce equivalent impedance of an electrolysis circuit so as to increase electrolysis current under a certain electrolysis voltage, thereby increasing the electrolysis efficiency. The following phenomena cannot be explained by the known knowledge: although the traditional water electrolysis machine uses the power of hundreds of watts and even a kilowatt order and current of a ten-ampere order, the electrolyzed reduced water indexes are difficult to reach the hydrogen content greater than 1000 ppb and the ORP value greater than −800 mv. The effect is not obvious even if the current is increased. Repeated experiments of the applicant prove that: for a certain electrolysis electrode structure, the electrolysis indexes have an increasing trend in a certain range of the current increase, however, beyond the range, the electrolysis indexes are not obviously increased even if the current is increased, and a condition that the indexes are not increased but decreased may occur. The reason is that the direction of solving the low efficiency problem is inaccurate due to an unknown electrolysis principle. After long-term in-depth study, the applicant discovers that: under a condition that a corresponding process-matched design does not exist because a true meaning of the small gap between the positive and the negative electrodes for increasing the electrolysis efficiency is not known, even if a product with a design solution of a small electrode gap is adopted, the water electrolysis efficiency cannot be obviously increased, so that high-efficiency electrolysis of the purified water and other water with low conductivity cannot be realized, and running water flowing through the positive and the negative electrodes at a time cannot be effectively electrolyzed. However, the novel water electrolysis principle and the produced novel method invented by the applicant fundamentally solve the problem that the water electrolysis efficiency cannot be increased.

A water electrolysis apparatus designed according to the novel water electrolysis principle and method of the applicant obtains ultrahigh water electrolysis efficiency. An experiment for making the reduced water through electrolysis in a water container shows that: the water electrolysis efficiency is greatly increased. Related test data is listed in Table 1:

TABLE 1
Experimental detection data of natural static water in a water electrolysis
container in the novel membrane-less water electrolysis method

| | | Structural characteristics | |
|---|---|---|---|
| | | Gap between the positive and the | Gap between the positive and the |
| | | negative electrodes is equal to 0.4 | negative electrodes is equal to 0.4 |
| | | mm (water between the positive and | mm (water between the positive and |
| | | the negative electrodes flows | the negative electrodes does not flow |
| Test items | | smoothly in the electrolysis process) | smoothly in the electrolysis process) |
| Reduced | ORP (mv) | −1082 | −562 |
| water | Hydrogen | 1285 | 656 |
| indexes | content | | |
| | (ppb) | | |

| | | |
|---|---|---|
| Electrolysis | 0.9 | 0.9 |
| current (A) | | |

Notes:
electrolysis voltage of 12 V, time of 1 minute, normal temperature, and raw water: ORP = +347 mv and hydrogen content = 0.

It can be seen from Table 1 that: the method in the present invention can enable the hydrogen content in the electrolyzed water to be close to an industry-recognized high level of a water saturated hydrogen content of 1.2-1.6 ppm, which is extremely high electrolysis efficiency unattainable in the current isolating-membrane-less water electrolysis technology. In addition, it can be seen from two columns of contrast data in the Table 1 that: the liquidity of the water in the electrode gap has an obvious influence on the electrolyzed water indexes during electrolysis. According to the present invention, cost performance, practicality and convenience of products can be greatly increased. When a cup of direct drinking water of about 350 ml is electrolyzed by a general isolating-membrane-less electrolysis method, the ORP reaches about −600 mv, the hydrogen content reaches about 600 ppb, and the needed electrolysis time is 8-10 minutes, while the same indexes can be reached within only 10 seconds by adopting the novel method for increasing the water electrolysis efficiency in the present invention. If the indexes are converted into comparable power for comparison, the water electrolysis efficiency is increased by more than 40-60 times.

According to the novel electrolysis method for obviously increasing electrolysis efficiency in the present invention, an experiment for making the reduced water by electrolyzing the running water driven by the external force at a time shows that: the obtained water electrolysis efficiency is particularly obviously increased, and the water electrolysis indexes can reach and even exceed those of existing isolating-membrane water electrolysis machines of famous brands. Related test data is listed in Table 2:

TABLE 2
Experimental detection data of the novel water electrolysis
method applied to electrolyzing the running water
driven by the external force at a time

| | | Structural characteristics | | | |
|---|---|---|---|---|---|
| | | Gap between the positive and the | | | |
| | | negative electrodes = 0.4 mm | | | |
| | | Running | | | |
| | | water | | Purified | Distilled |
| | | at room | Boiled | water | water |
| | | temper- | running | (conduc- | (conduc- |
| Test items | | ature | water | tivity = 0) | tivity = 0) |
| Reduced | ORP (mv) | −880 | −805 | −662 | −589 |
| water | Hydrogen | 875 | 798 | 656 | 607 |
| indexes | content | | | | |
| | (ppb) | | | | |

| | | | | |
|---|---|---|---|---|
| Electrolysis | 1.5 | 1.6 | 1.3 | 1.3 |
| current (A) | | | | |

Notes:
electrolysis voltage of 7 V, normal temperature, and the raw water: ORP = +345-408 mv and hydrogen content = 0.

Data in the Table 2 proves that: according to the novel electrolysis method for obviously increasing water electrolysis efficiency in the present invention, running water (comprising reverse osmosis membrane filtered water, commercially available purified water, distilled water and the like) of any temperature and conductivity capable of flowing through the gap between the positive and the negative electrodes at a time can be electrolyzed at high efficiency, which has never been reached in the existing isolating-membrane-less water electrolysis technology. The present method is quite qualified for making a direct-drinking water electrolysis machine for discharging one kind of electrolyzed water (such as the electrolyzed reduced water) without any acidic water at all. Electrolysis power of the direct-drinking water electrolysis machine is several watts only, the efficiency is improved by dozens of times and even more than one hundred times compared with the water electrolysis machine with the isolating membrane technology needing power of hundreds of watts, and the following defects of the water electrolysis machine are overcome: the electrolysis efficiency of the water electrolysis machine is too low, the water electrolysis machine is fixed with a water tap to be used and cannot be carried, the acidic water and alkaline water must be simultaneously respectively discharged, the ORP negative value and alkalinity of the water are interdependent and the like. Therefore, according to the novel water electrolysis principle and method, various portable and domestic water electrolysis apparatuses for drinking water, used water and the like can be designed and produced.

Since the ORP negative value and the hydrogen content index in the reduced water made by the novel membrane-less water electrolysis method in the present invention can be almost unrelated to a pH value of the water, and various kinds of drinking water such as boiled water, the purified water and the like can be electrolyzed, the reduced water is suitable for wide popularization and drinking and contributes to comprehensively promoting human health. The method avoids wastewater emission and has obvious low-carbon and environmental-friendly advantages of saving energy, water and materials and the like. The experiments prove that the novel method for obviously increasing water electrolysis efficiency provides a great feasibility and convenience for popularization and application of the water electrolysis apparatus, and can be expected to achieve a great promoting effect for upgrading the water electrolysis technology.

The novel water electrolysis principle discovered by the applicant discloses a novel membrane-less water electrolysis method for obviously increasing electrolysis efficiency, wherein the water electrolysis method focuses on enabling more impurities in water to be electrolyzed to produce more electrons and conductive ions, and creating good conditions to increase water electrolysis efficiency while forming electrolytic current to enable more electric energy to be changed into water molecule decomposition energy. The electrolysis electrode assembly for realizing the water electrolysis method has features as follows: the spacing of the gap reserved between the positive electrode and the negative electrode is designed according to a reasonable minimization principle, and the gap is less than 5 mm and more than 0 mm, thereby benefiting enhancement of electrolysis between the impurities and the water molecules in the water; the area of the gap between the positive and the negative electrodes is designed according to a reasonable maximization principle in a certain space occupied by the electrolysis electrode assembly, so that more impurities and water molecules in the water can be repeatedly electrolyzed in the electrode gap; and the electrolysis electrode assembly and the mounting process conditions thereof have features as follows: in the water electrolysis process, the water can smoothly flow in the gap between the positive and the negative electrodes, so that the water electrolyzed in the electrode gap can be replaced, more impurities and water molecules are repeatedly electrolyzed by the positive and the negative electrodes, and the probability and quantities of the impurities and the water molecules electrolyzed by the positive and the negative electrodes are increased, thereby increasing the electrolysis efficiency of the water.

According to the novel electrolysis method for obviously increasing water electrolysis efficiency, for the electrolysis electrode assembly, under the condition that the needed certain liquidity of the water in the gap of the positive and the negative electrodes is met, the gap between the positive and the negative electrodes of the electrolysis electrode assembly can be 1 mm or smaller when necessary, thereby benefiting enhancement of the electrolysis of the impurities and the water molecules in the water and increase of the water electrolysis efficiency under a certain electrolysis power and a certain electrolysis electrode assembly structure.

According to the novel electrolysis method for obviously increasing water electrolysis efficiency, the electrolysis electrode assembly can make daily drinking water and the used water into the electrolyzed reduced water with the oxidation-reduction potential of a negative value and hydrogen content greater than zero.

According to the novel electrolysis method for obviously increasing water electrolysis efficiency, for the electrolysis electrode assembly, in case of electrolysis of the natural static water, the structures of the positive and the negative electrodes are designed as follows: when the water in the electrode gap is electrolyzed to produce fluidity, the water and ions in the electrode gap can flow hereby, then more water flows through the gap between the positive and the negative electrodes, and the water electrolyzed in the gap is replaced, so that more impurities and water molecules in the water can be repeatedly electrolyzed by current between the positive and the negative electrodes, and the probability and the quantities of the impurities and the water molecules electrolyzed by the positive and the negative electrodes are increased, thereby increasing the electrolysis efficiency of the water.

According to the novel electrolysis method for obviously increasing water electrolysis efficiency, for the electrolysis electrode assembly, a certain space is reserved outside positions at two ends of the electrode gap, so that the water can smoothly flow in and out the gap between the positive and the negative electrodes while flowing in the electrolyzed process, thereby increasing the electrolysis efficiency of the water.

According to the novel electrolysis method for obviously increasing water electrolysis efficiency, for the electrolysis electrode assembly, in case of electrolysis of the running water driven by the external force, time of electrolyzing the running water in the electrode gap can be prolonged in a certain space occupied by the electrolysis electrode assembly by reasonably increasing the area of the electrode gap, so that more impurities and the water molecules can be repeatedly electrolyzed by the positive and the negative electrodes, and the probability and the quantities of the impurities and the water molecules electrolyzed by the positive and the negative electrodes are increased, thereby increasing the electrolysis efficiency of the water.

According to the novel electrolysis method for obviously increasing water electrolysis efficiency, for the electrolysis electrode assembly, in case of electrolysis of the running water driven by the external force, a water outlet channel of the electrolysis electrode assembly is designed to be narrower than a water inlet channel to appropriately relieve flow velocity of water flowing into the gap of the electrolysis electrodes, so that more impurities and the water molecules can be repeatedly electrolyzed by current between the positive and the negative electrodes, and the probability and the quantities of the impurities and the water molecules electrolyzed by the positive and the negative electrodes are increased, thereby increasing the electrolysis efficiency of the water.

According to the novel electrolysis method for obviously increasing water electrolysis efficiency, under a condition that a wall material and a shape of a shell, such as a running water pipeline or a container liner, coating the electrolysis electrode assembly are suitable for serving as the positive and the negative electrodes, the electrolysis electrode assembly can be properly connected to serve as an electrolysis electrode, thereby increasing the area of the electrolysis gap between the positive and the negative electrodes and increasing the electrolysis efficiency of the water.

According to the novel electrolysis method for obviously increasing water electrolysis efficiency, the electrolysis electrode assembly is composed of two electrodes of different polarities; one electrode is holed, a hole wall position of each hole is mechanically fixed, and hole walls are mutually and electrically connected with one another; a quantity of columns of cylindrical electrodes is N and N ranges from 1 to an arbitrary value; and the other electrode is cylindrical, various columns are mechanically fixed and mutually electrically connected with one another, a quantity of the holes of the holed electrodes is M and M ranges from 1 to an arbitrary value. The holed electrodes and the cylindrical electrodes are correspondingly inserted, i.e., each column of the cylindrical electrodes is inserted into each corresponding hole of the cylindrical electrodes, and a gap in which the water can be electrolyzed is reserved between a cylindrical surface and a holed surface correspondingly inserted; the water in the electrode gap can flow in an electrolysis operating process; and a certain space is reserved outside positions at two ends of the electrode gap, so that the water can flow in the gap between the positive and the negative electrodes in the electrolyzed process.

According to the novel electrolysis method for obviously increasing water electrolysis efficiency, the electrolysis electrode assembly is composed of two groups of cylindrical electrodes of different polarities, each group comprises N cylindrical electrodes, and N ranges from 1 to an arbitrary value; a position of each cylindrical electrode in each group is relatively fixed, the two groups of cylindrical electrodes can be mutually assembled in an inserted manner, and an electrode gap for electrolysis of water is reserved on an opposite cylindrical surface of each pair of adjacent cylindrical electrodes of different polarities.

According to the novel electrolysis method for obviously increasing water electrolysis efficiency, for the electrolysis electrode assembly, a structure of one of the electrodes of different polarities has a shape of E, a structure of the other of the electrodes has a shape of E inverted in left and right, and the E-shaped electrode and the inverted E-shaped electrode form a Z-shaped electrode gap in a concave-convex insertion manner; and N E-shaped electrodes can be stacked, can be inserted with N stacked inverted E-shaped electrodes in a concave-convex manner to form a plurality of connected Z-shaped electrode gaps, and N ranges from 1 to an arbitrary value.

According to the novel electrolysis method for obviously increasing water electrolysis efficiency, the electrolysis electrode assembly is composed of two groups of N electrode plates of different polarities, and N ranges from 1 to an arbitrary value; and the two groups of electrode plates are mutually assembled in an inserted manner, and an electrode gap and a gap area are formed between opposite plate surfaces of each pair of adjacent electrode plates of different polarities.

According to the novel electrolysis method for obviously increasing water electrolysis efficiency, the electrolysis electrode assembly can increase the electrolysis efficiency by adopting a design that the positive and the negative electrodes have unequal areas, and the unequal areas of the positive and the negative electrodes may be reflected as follows: the area of the positive electrode is larger than the area of the negative electrode, or vice versa; and a horizontal projection of an electrode plate in a high-level position is equal to or smaller than a horizontal projection of an electrode plate in a low-level position, thereby increasing the electrolysis efficiency of the water.

Based on the technical solutions, the water electrolysis method focuses on enabling more impurities in water to be electrolyzed to produce many electrons and conductive ions, and creating good conditions to increase water electrolysis efficiency while forming electrolytic current to enable more electric energy to be changed into water molecule decomposition energy. The electrolysis electrode assembly for realizing the present water electrolysis method has features as follows: the spacing of the gap reserved between the positive electrode and the negative electrode is designed according to a reasonable minimization principle, and the gap is less than 5 mm and more than 0 mm, thereby benefiting enhancement of electrolysis between the impurities and the water molecules in the water; the area of the gap between the positive and the negative electrodes is designed according to a reasonable maximization principle in a certain space occupied by the electrolysis electrode assembly, so that more impurities and water molecules in the water can be repeatedly electrolyzed in the electrode gap; and the electrolysis electrode assembly and the mounting process conditions thereof have features as follows: in the water electrolysis process, the water can smoothly flow in the gap between the positive and the negative electrodes, so that the water electrolyzed in the gap between the positive and the negative electrodes can be replaced, many impurities and water molecules are repeatedly electrolyzed by the positive and the negative electrodes, and the probability and quantities of the impurities and the water molecules electrolyzed by the positive and the negative electrodes are increased, thereby increasing the electrolysis efficiency of the water; the above three technological points are well coordinated and simultaneously considered in the design solution, so that the efficiency for electrolyzing the impurities and the water molecules in the water can be maximized; under the condition that the certain liquidity of the water in the gap between the positive and the negative electrodes is met, the spacing between the positive and the negative electrodes of the electrolysis electrode assembly can be as small as 1 mm or smaller, thereby benefiting enhancement of the electrolysis of the impurities and the water molecules in the water and obtaining high water electrolysis efficiency under a certain electrolysis power and a certain electrolysis electrode assembly structure, and particularly the purified water, the distilled water and other raw water with low conductivity can be efficiently electrolyzed.

As a technical solution for electrolyzing the natural static water, designs of the structures of the positive and the negative electrodes and operating conditions thereof are as follows: when the water in the electrode gap is electrolyzed to produce ascending hydrogen bubbles and oxygen bubbles, the water and ions in the electrode gap can smoothly flow, so that more water flows through the gap between the positive and the negative electrodes and the water electrolyzed in the electrode gap can be replaced, so that more impurities and water molecules are repeatedly electrolyzed by the current between the positive and the negative electrodes, and the probability and quantities of the impurities and the water molecules electrolyzed by the positive and the negative electrodes are increased, thereby increasing the electrolysis efficiency of the water. In view of this, a certain space should be reserved outside positions at ends of the electrode gap in the electrolysis electrode assembly, so that the water can smoothly flow in and out the gap between the positive and the negative electrodes while flowing in the electrolyzed process. Through the design solution, the electrolyzed water in the electrolysis electrode assembly gradually diffuses to a periphery, and water at the periphery is absorbed to enter the electrode gap to be electrolyzed, thereby forming rounds of water electrolysis cycles for improving water electrolysis indexes at the periphery of the electrode assembly. The experiment shows that the above design points are of great importance for realizing high-efficiency electrolysis and high water electrolysis indexes.

As a technical solution for electrolyzing the running water driven by the external force, it should be considered that: the liquidity of the water is easily met, however, insufficient electrolysis strength and low water electrolysis indexes are easily caused due to short water electrolysis time. Therefore, the designs of the structures of the positive and the negative electrodes and the operating conditions thereof should be as follows: in order to achieve expected electrolysis efficiency and effects, the quantities of the electrolyzed water molecules and impurities are managed to be increased, the time of electrolyzing the running water in the electrode gap shall be prolonged, and a preferred solution is to reasonably increase the area of the electrode gap and properly select the small electrode gap in a certain space occupied by the electrolysis electrode assembly, so that many impurities and water molecules can be promoted to be repeatedly electrolyzed by the current between the positive and the negative electrodes, the probability and the quantities of the impurities and the water molecules electrolyzed by the positive and the negative electrodes are increased, and the electrolysis strength is increased, thereby increasing the electrolysis efficiency of the water. In addition, a technical solution of appropriately decreasing the flow velocity of the water to prolong the electrolysis time in the electrolysis gap can be adopted under a condition that a certain need for flow of the water is met. For example, a design of the water outlet channel of the electrolysis electrode assembly to be narrower than the water inlet channel is also a preferred design solution, so that the flow velocity of the water flowing into the electrolysis electrode gap is decreased, the time of electrolyzing the water in the gap is prolonged, many impurities and water molecules can be promoted to be repeatedly electrolyzed by the current between the positive and the negative electrodes, and the probability and the quantities of the impurities and the water molecules electrolyzed by the positive and the negative electrodes are increased, thereby increasing the electrolysis efficiency of the water. The experiment shows that the above design can realize high water electrolysis efficiency and high electrolysis efficiency indexes.

An auxiliary design solution of the present invention is as follows: under the condition that the material and the shape of the shell, such as the running water pipeline or the container liner wall, coating the electrolysis electrode assembly are suitable for serving as the positive and the negative electrodes, the electrolysis electrode assembly can be properly connected to serve as the electrolysis electrode, thereby increasing the area of the electrolysis gap between the positive and the negative electrodes and increasing the electrolysis efficiency of the water.

A first technical design solution of the electrolysis electrode assembly and process conditions thereof in the present invention is as follows: the electrolysis electrode assembly is composed of two electrodes of different polarities; one electrode is holed, a hole wall position of each hole is mechanically fixed, and hole walls are mutually and electrically connected with one another; the quantity of columns of the cylindrical electrodes is N and N ranges from 1 to an arbitrary value; and the other electrode is cylindrical, various columns are mechanically fixed and mutually electrically connected with one another, the quantity of the holes of the holed electrodes is M and M ranges from 1 to an arbitrary value. The holed electrodes and the cylindrical electrodes are correspondingly inserted, i.e., each column of the cylindrical electrodes is inserted into each corresponding hole of the holed electrodes, and a gap in which the water can be electrolyzed is reserved between the cylindrical surface and the holed surface correspondingly inserted; the water in the electrode gap can flow in the electrolysis operating process; and a certain space is reserved outside positions at two ends of the electrode gap, so that the water can flow in the gap between the positive and the negative electrodes in the electrolyzed process.

A second technical design solution of the electrolysis electrode assembly and process conditions thereof in the present invention is as follows: the electrolysis electrode assembly is composed of two groups of cylindrical electrodes of different polarities, each group comprises N cylindrical electrodes, and N ranges from 1 to an arbitrary value; a position of each cylindrical electrode in each group is relatively fixed, the two groups of cylindrical electrodes can be mutually assembled in an inserted manner, and an electrode gap for electrolysis of water is reserved on an opposite cylindrical surface of each pair of adjacent cylindrical electrodes of different polarities.

A third technical design solution of the electrolysis electrode assembly and process conditions thereof in the present invention is as follows: for the electrolysis electrode assembly, a structure of one of the electrodes of different polarities has a shape of E, a structure of the other of the electrodes has a shape of E inverted in left and right, and the E-shaped electrode and the inverted E-shaped electrode form a Z-shaped electrode gap in a concave-convex insertion manner; and N E-shaped electrodes can be stacked, can be inserted with N stacked inverted E-shaped electrodes in a concave-convex manner to form a plurality of connected Z-shaped electrode gaps, and N ranges from 1 to an arbitrary value.

A fourth technical design solution of the electrolysis electrode assembly and process conditions thereof in the present invention is as follows: the electrolysis electrode assembly is composed of two groups of N electrode plates of different polarities respectively, and N ranges from 1 to an arbitrary value; and the two groups of electrode plates are mutually assembled in an inserted manner, and an electrode gap and a gap area are formed between opposite plate surfaces of each pair of adjacent electrode plates of different polarities.

A fifth technical design solution of the electrolysis electrode assembly and process conditions thereof in the present invention is as follows: the electrolysis electrode assembly can increase the electrolysis efficiency by adopting the design that the positive and the negative electrodes have unequal areas, and the unequal areas of the positive and the negative electrodes may be reflected as follows: the area of the positive electrode is larger than the area of the negative electrode, or vice versa; and a horizontal projection of an electrode plate in a high-level position is equal to or smaller than a horizontal projection of an electrode plate in a low-level position, thereby obtaining high electrolysis efficiency.

### DESCRIPTION OF DRAWINGS

FIG. 1A-B are implementation apparatus of a novel membrane-less water electrolysis method for obviously increasing electrolysis efficiency in embodiment 1 of the present invention.

FIG. 2 is an implementation apparatus of a novel membrane-less water electrolysis method for obviously increasing electrolysis efficiency in embodiment 2 of the present invention.

FIG. 3 is an implementation apparatus of a novel membrane-less water electrolysis method for obviously increasing electrolysis efficiency in embodiment 3 of the present invention.

FIG. 4 is an implementation apparatus of a novel membrane-less water electrolysis method for obviously increasing electrolysis efficiency in embodiment 4 of the present invention.

FIG. 5 is an implementation apparatus of a novel membrane-less water electrolysis method for obviously increasing electrolysis efficiency in embodiment 5 of the present invention.

### DETAILED DESCRIPTION

Basic structures and basic operating principles of embodiments are summarized in combination with drawings 1-5 in embodiments 1-5 as follows:

1 and 2 are electrodes of different polarities in an electrolysis electrode assembly; 3 is a gap between electrodes of different polarities, and a spacing of the gap is 0-5 mm; 8 is an electrolytic cell wall (generally a water container shell or a water-through pipe wall, etc.), or can be a shell equipped with the electrolysis electrode assembly; 10 is an inner space of the electrolytic cell; 11 and 12 are respectively nearby spaces outside two ends of the electrode gap; 4 is a communicating gap between the electrode 1 and the electrolytic cell wall 8, and a spacing of the gap is 0-5 mm; 9 is an electrolysis power supply; and 6 and 7 are wires for respectively connecting the electrodes 1 and 2 of different polarities to two power output ports of the electrolysis power supply 9. During an electrolysis operation, the electrode assembly composed of the electrodes 1 and 2 is soaked in to-be-electrolyzed water, the power supply 9 supplies power to the electrodes 1 and 2 through the wires 6 and 7, water in the gap between the electrodes 1 and 2 is electrolyzed by current, and partial impurities and water molecules in the water are electrolyzed to produce water electrolysis indexes. Specific features of each embodiment are respectively described in description.

### Embodiment 1

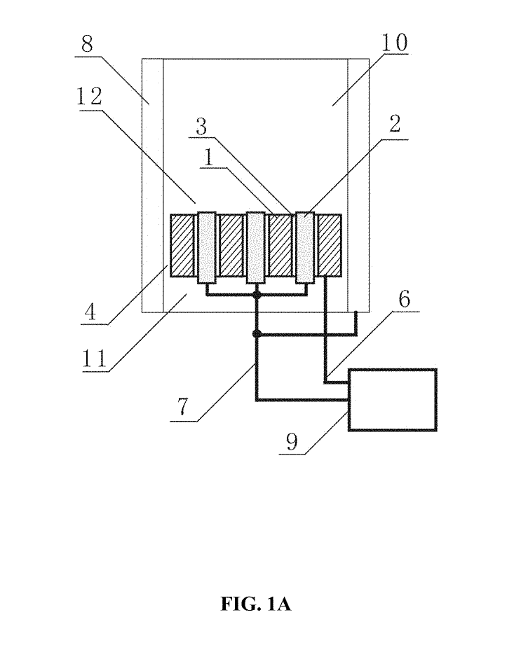

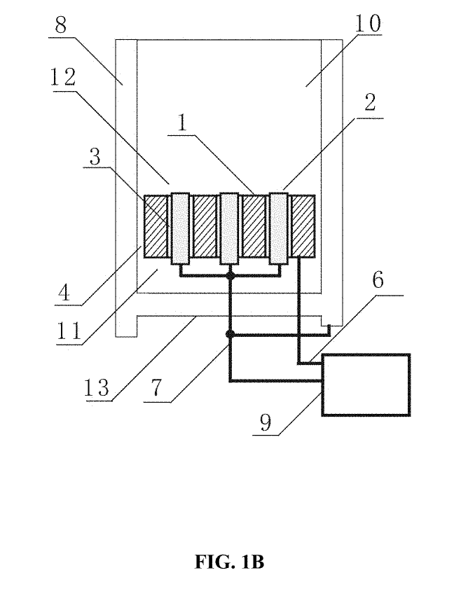

As shown in FIG. 1A, the present invention is used for electrolyzing running water driven by an external force. An electrolysis electrode assembly is composed of two electrodes 1 and 2 of different polarities. The electrode 1 is holed, the electrode 2 is cylindrical, the electrodes 1 and 2 can be correspondingly inserted, columns of the cylindrical electrode 2 are inserted into corresponding holes of the holed electrode, and an electrolysis gap 3 is reserved between a cylindrical surface and a holed surface and is tubular. FIG. 1 schematically shows the gap 3 formed by three cylindrical electrodes and the holed electrode. A spacing of the gap can be selected in a certain range as needed, such as a range less than 5 mm to more than 0 mm. When necessary, the spacing of the gap 3 can be a smaller value, i.e. equal to or less than 1 mm, so that an electrolysis effect of water and impurities in the water is enhanced. When raw water with low conductivity, such as purified water, distilled water and the like, needs to be electrolyzed by an apparatus, high water electrolysis efficiency and indexes can be obtained. A probability and quantities of electrolyzed impurities and water molecules is in direct proportion to an area of the gap under a condition that the distance of the gap of the electrodes is constant, so the electrolysis efficiency can be improved by maximizing the area of the spacing 3. In FIG. 1, the electrolytic cell wall 8 is a material suitable for serving as an electrolysis electrode, is connected to the electrolysis power supply via the wire 7 to become part of the electrode 2, and forms an electrolysis gap 4 with the electrode 1, thereby enhancing the electrolysis effect of the apparatus; 11 and 12 are respectively a lower space and an upper space of the electrolytic cell 10, and when the spaces 11 and 12 are designed with a certain volume, the water in the electrode gap is helped to smoothly flow. Since hydrogen and oxygen are produced after the water molecules in the gap are electrolyzed and decomposed in the water electrolysis process, and hydrogen and oxygen bubbles upwards ascend along the gap so as to drive the water in the gap 3 to flow upwards and then flow out of the space 12 from an upper port of the gap 3, the water continuously flows into the electrode gap for supplementing from an outside of a lower port of the gap 3, i.e. the space 11. Apparently, if the 11 and 12 are too narrow, liquidity of the water in the electrode gap may be influenced, thereby decreasing the electrolysis efficiency of the water. In conclusion, the small spacing and large area of the gap 3 are reasonably selected, a certain liquidity of the water in the gap 3 is met, and technical solutions that coordinate and simultaneously consider the three aspects can obviously increased the electrolysis efficiency. Since the apparatus is used for electrolyzing the running water, generally speaking, if the spaces 11 and 12 outside the ports of the gap 3 are open enough, the liquidity of the water in the gap may be easily met. A remarkable point is another problem which may cause a decrease of the water electrolysis efficiency as follows: if flow velocity of the running water flowing into the electrolytic cell is too high, flow velocity of the water flowing through the electrode gap will also be too high, so that the electrolysis efficiency may be decreased. Therefore, when the apparatus is applied to electrolyzing the running water with too high flow velocity, a design of properly decreasing the flow velocity of a water flow in the electrolytic cell can be adopted on the basis of meeting a flow need of the apparatus. A simpler solution is as follows: a water outlet of the electrolytic cell 10 is designed to be obviously narrower than a water inlet. For example, in FIG. 1, assuming that the space 11 is a water inlet of the electrolytic cell 8 and the space 12 is a water outlet of the electrolytic cell 8, the space 12 is designed to be a little narrower than the space 11, so that the flow velocity of the water flowing through the electrolytic cell is decreased, while the flow velocity of the water entering the electrode gap is naturally properly decreased, thereby prolonging time of electrolyzing the water in the gap and enhancing the electrolysis effect of the water. Certainly, as mentioned before, the space 12 shall not be too narrow, otherwise a certain liquidity needed by the water in the gap 3 is influenced, and the electrolysis efficiency and water electrolysis indexes may be decreased.

As shown in FIG. 1B, the present invention is used for electrolyzing conditions of natural static water in the electrolytic cell 10. Compared with FIG. 1A, a difference is only that the electrolytic cell is designed to have a bottom 13. Unnecessary details for the parts described in FIG. 1A are avoided. The space 11 is positioned between the bottom 13 of the electrolytic cell and a bottom of the electrolysis electrode assembly, and when the spaces 11 and 12 are designed with a certain volume, the water in the electrode gap is helped to smoothly flow. Since hydrogen and oxygen are produced after the water molecules in the gap are electrolyzed and decomposed in the water electrolysis process, and hydrogen and oxygen bubbles upwards ascend along the gap so as to drive the water in the gap 3 to flow upwards and then flow out of the space 12 from an upper port of the gap 3, the water continuously flows into the electrode gap for supplementing from an outside of a lower port of the gap 3, i.e. the space 11, while the water in the electrolytic cell spaces 12 and 10 supplements the 11 from the gap 4 or 3. In a flowing process of the water in the gap, the impurities and the water molecules in the water will be repeatedly electrolyzed by electrolysis current in the gap. By repeatedly cycling, the water in the electrolytic cell will repeatedly flow into the electrode gap and will be repeatedly electrolyzed, thereby continuously enhancing the electrolysis effect. Apparently, if the 11 and 12 are too narrow, liquidity of the water in the electrode gap may be influenced, thereby decreasing the electrolysis efficiency of the water. In conclusion, the small spacing and large area of the gap 3 are reasonably selected, a certain liquidity of the water in the gap 3 is met, and the technical solutions that coordinate and simultaneously consider the three aspects can obviously increase the electrolysis efficiency.

Refer to related test data in Table 3 and Table 4 for indexes of the experimental device:

TABLE 3
Experimental detection data of natural static water (direct drinking
water) in a water electrolysis container in the present embodiment

| | | Structural characteristics |
|---|---|---|
| | | Gap between the positive and the negative |
| | | electrodes = 0.4 mm (water between the |
| | | positive and the negative electrodes flows |
| Test items | | smoothly in the electrolysis process) |
| Reduced | ORP (mv) | −978 |
| water | Hydrogen | 1062 |
| indexes | content | |
| | (ppb) | |

| | |
|---|---|
| Electrolysis | 0.7 |
| current (A) | |

Notes:
electrolysis voltage of 8 V, time of 1 minute, normal temperature, and raw water: ORP = +347 mv and hydrogen content = 0. It can be seen that the method in the present invention can enable the hydrogen content in the electrolyzed water to be close to an industry-recognized high level of a water saturated hydrogen content of 1.2-1.6 ppm, which is extremely high electrolysis efficiency unattainable in the current isolating-membrane-less water electrolysis technology. When a cup of direct drinking water of about 350 ml is electrolyzed by a general isolating-membrane-less electrolysis method, the ORP reaches about −600 mv, the hydrogen content reaches about 600 ppb, and the needed electrolysis time is 8-10 minutes, while the same indexes can be reached within only 10 seconds by adopting the novel method for increasing the water electrolysis efficiency in the present invention. If the indexes are converted into comparable power for comparison, the water electrolysis efficiency is increased by dozens of times and even more than one hundred times or higher.

According to the novel electrolysis method for obviously increasing water electrolysis efficiency in the present invention, an experiment for making the reduced water by electrolyzing the running water driven by the external force at a time shows as follows: the obtained water electrolysis efficiency is particularly obviously increased, and the water electrolysis indexes can reach and even exceed those of the existing isolating-membrane water electrolysis machines of famous brands. Related test data is listed in Table 2:

TABLE 4
Experimental detection data of the novel water electrolysis method
applied to electrolyzing the direct-drinking running water

| | | Structural characteristics | |
|---|---|---|---|
| | | Gap between the positive and the | |
| | | negative electrodes = 0.4 mm | An existing water electrolysis |
| | | (water between the positive and | machine of a certain brand |
| | | the negative electrodes flows | adopting the isolating membrane |
| Test items | | smoothly in the electrolysis process) | technology in the market |
| Reduced | ORP (mv) | −926 | −810 |
| water | Hydrogen | 962 | 798 |
| indexes | content | | |
| | (ppb) | | |

| | | |
|---|---|---|
| Electrolysis | 0.8 | |
| current (A) | | |
| Power | 4.8 W | 200 W |

Notes:
electrolysis voltage of 6 V, normal temperature, and raw water: ORP = +368 mv and hydrogen content = 0. The detection data shows that the electrolysis efficiency of the water electrolysis technology is dozens of times that of an existing water electrolysis machine adopting the isolating membrane technology in a market.

### Embodiment 2

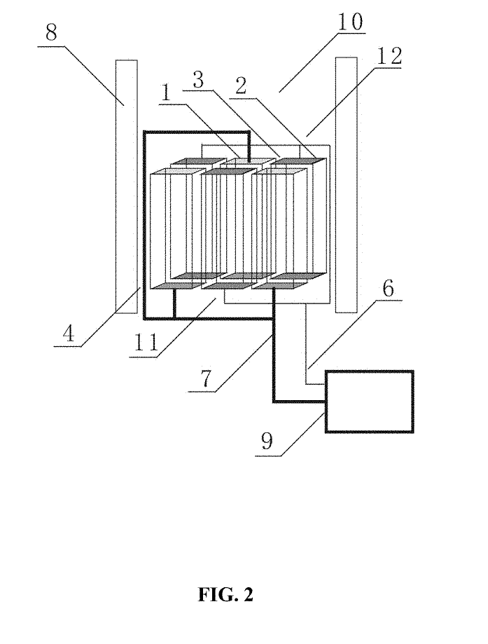

As shown in FIG. 2, the electrolysis electrode assembly is composed of two groups of cylindrical electrodes 1 and 2 of different polarities, each group comprises N cylindrical electrodes, N ranges from 1 to an arbitrary value, and N is equal to 3 as shown in FIG. 2; positions of three cylindrical electrodes in each group are relatively fixed, the two groups of three cylindrical electrodes can be mutually assembled in an inserted manner, and an electrode gap 3 for electrolysis of water and an area of the gap are formed on opposite cylindrical surfaces of each pair of adjacent cylindrical electrodes of different polarities. Totally 7 electrode gaps 3 exist in the FIG. 2. The gap 4 generally can be 0 mm. For significances of the designs of properly maximizing areas of the gaps between the electrodes of different polarities and properly minimizing the spacing of the gaps for increasing the water electrolysis efficiency, and special design solutions and description thereof for respectively increasing the water electrolysis efficiency under two conditions of electrolysis of the running water and the natural static water, refer to related contents in embodiment 1.

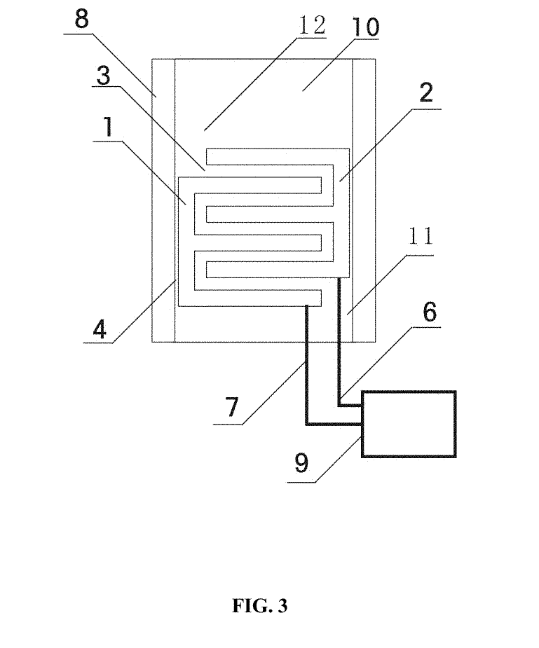

TABLE 5
Experimental detection data of the novel water electrolysis
method shown in FIG. 3 applied to electrolyzing the
direct drinking water in the container

| | | Structural characteristics |
|---|---|---|
| | | Gap between the positive and the negative |
| | | electrodes = 0.4 mm (water between the |
| | | positive and the negative electrodes flows |
| Test items | | smoothly in the electrolysis process) |
| Reduced | ORP (mv) | −1273 |
| water | Hydrogen | 1325 |
| indexes | content | |
| | (ppb) | |

| | |
|---|---|
| Electrolysis | 1.2 |
| current (A) | |

Notes:
electrolysis voltage of 9 V, normal temperature, electrolysis time of 1 minute, and raw water: ORP = +481 mv and hydrogen content = 0.

### Embodiment 3

As shown in FIG. 3, in the electrolysis electrode assembly, a structure of one of the electrodes of different polarities, i.e. 1, has a shape of E, a structure of the other of the electrodes, i.e. 2, has a shape of E inverted in left and right, and the E-shaped electrode and the inverted E-shaped electrode form an arched electrode gap 3 in a concave-convex insertion manner; and N E-shaped electrodes can be stacked, can be inserted with N stacked inverted E-shaped electrodes in a concave-convex manner to form a plurality of connected arched electrode gaps and gap areas thereof, and N ranges from 1 to an arbitrary value. The gap 4 generally can be 0 mm. For significances of the designs of properly maximizing areas of the gaps between the electrodes of different polarities and properly minimizing the spacing of the gaps for increasing the water electrolysis efficiency, and special design solutions and description thereof for respectively increasing the water electrolysis efficiency under two conditions of electrolysis of the running water and the natural static water, refer to the related contents in embodiment 1.

TABLE 5
Experimental detection data of the novel water electrolysis
method shown in FIG. 3 applied to electrolyzing the
direct-drinking running water at a time

| | | Structural characteristics |
|---|---|---|
| | | Gap between the positive and the negative |
| | | electrodes = 0.4 mm (water between the |
| | | positive and the negative electrodes flows |
| Test items | | smoothly in the electrolysis process) |
| Reduced | ORP (mv) | −833 |
| water | Hydrogen | 857 |
| indexes | content | |
| | (ppb) | |

| | |
|---|---|
| Electrolysis | 1.5 |
| current (A) | |

### Embodiment 4

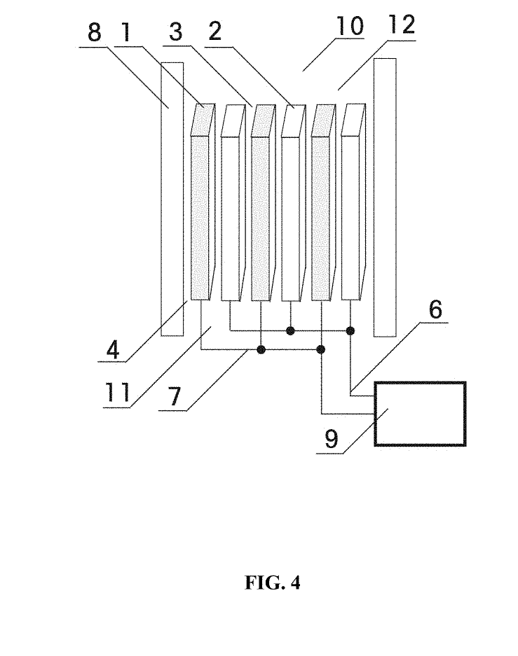

As shown in FIG. 4, the electrolysis electrode assembly is composed of two groups of N electrode plates 1 and 2 of different polarities, and N ranges from 1 to an arbitrary value; and the two groups of electrode plates 1 and 2 are mutually assembled in an inserted manner, an electrode gap 3 and a gap area are formed between opposite plate surfaces of each pair of adjacent electrode plates of different polarities, and FIG. 4 schematically shows five electrode gaps 3. For significances of the designs of properly maximizing areas of the gaps between the electrodes of different polarities and properly minimizing the spacing of the gaps for increasing the water electrolysis efficiency, and special design solutions and description thereof for respectively increasing the water electrolysis efficiency under two conditions of electrolysis of the running water and the natural static water, refer to related contents in embodiment 1.

TABLE 6
Experimental detection data of the novel water electrolysis
method shown in FIG. 4 applied to electrolyzing the
direct-drinking running water at a time

| | | Structural characteristics |
|---|---|---|
| | | Gap between the positive and the negative |
| | | electrodes = 0.4 mm (water between the |
| | | positive and the negative electrodes flows |
| Test items | | smoothly in the electrolysis process) |
| Reduced | ORP (mv) | −911 |
| water | Hydrogen | 837 |
| indexes | content | |
| | (ppb) | |

| | |
|---|---|
| Electrolysis | 1.5 |
| current (A) | |

Notes:
electrolysis voltage of 9 V, normal temperature, and raw water: ORP = +406 mv and hydrogen content = 0.

### Embodiment 5

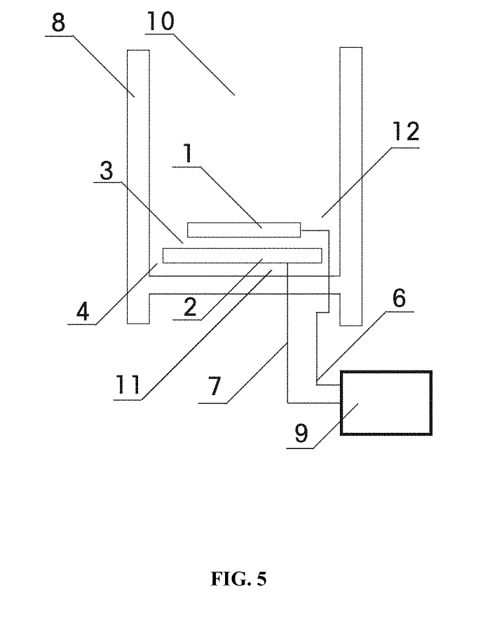

As shown in FIG. 5, a horizontal projection of the electrode plate 1 in a high-level position is smaller than a horizontal projection of the electrode plate 2 in a low-level position, and the bubbles escaping from the gap 3 between the electrodes 1 and 2 can directly ascend along edges of the electrodes to promote the water in the gap to flow, thereby obtaining high electrolysis efficiency. On the contrary, the experiment proves that: if an area of the electrode 1 is greater than an area of the electrode 2, the bubbles escaping from the gap will be blocked by part of the area of the electrode 1 exceeding that of the electrode 2, so the bubbles are gathered to hinder flow of the bubbles and the water in the gap, thereby decreasing the water electrolysis efficiency. Experimental detection data under the condition that the two electrodes have unequal areas is listed in FIG. 7. Accuracy of the above analysis is proved, and the liquidity of the water in the electrode gap is proved to have significances on the electrolysis efficiency and indexes in the electrolysis process. With respect to significances of the designs of properly maximizing areas of the gaps between the positive and the negative electrodes and minimizing the spacing of the gaps for increasing the water electrolysis efficiency, and special design requirements and description for respectively increasing the water electrolysis efficiency under two conditions of electrolysis of the running water and the natural static water, refer to the related contents in embodiment 1. For significances of the designs of properly maximizing areas of the gaps between the electrodes of different polarities and properly minimizing the spacing of the gaps for increasing the water electrolysis efficiency, and special design solutions and description thereof for respectively increasing the water electrolysis efficiency under two conditions of electrolysis of the running water and the natural static water, refer to the related contents in embodiment 1.

TABLE 7
Experimental detection data of the water electrolysis apparatus of different electrode
structures shown in FIG. 2 in the present method and the non-present method

| | | Structural characteristics | |
|---|---|---|---|
| | | An area positioned at the upper | An area of the electrode 1 is |
| | | electrode is smaller than an area | smaller than an area of the |
| | | positioned at the lower electrode in | electrode 2 (water between |
| | | FIG. 2A (water between the positive | the positive and the negative |
| | | and the negative electrodes flows | electrodes does not flow |
| Test items | | smoothly in the electrolysis process) | smoothly in the electrolysis process) |
| Reduced | ORP (mv) | −553 | −294 |
| water | Hydrogen | 585 | 351 |
| indexes | content | | |
| | (ppb) | | |

| | | |
|---|---|---|
| Electrolysis | 0.8 | 0.8 |
| current (A) | | |

Notes:
electrolysis voltage of 10 V, normal temperature direct-drinking water, and raw water: ORP = +381 mv and hydrogen content = 0.

What is claimed is:

1. A novel membrane-less water electrolysis method for obviously increasing electrolysis efficiency, focusing on enabling more impurities in water to be electrolyzed to produce electrons and conductive ions, and creating good conditions to increase water electrolysis efficiency while forming electrolytic current to enable more electric energy to be changed into water molecule decomposition energy, comprising:
designing a spacing of a gap reserved between a positive electrode and a negative electrodes according to a reasonable minimization principle, and the gap is less than 5 mm and more than 0 mm, thereby benefiting enhancement of electrolysis between the impurities and the water molecules in the water; and
designing an area of the gap between the positive and the negative electrodes according to a reasonable maximization principle in a certain space occupied by the electrolysis electrode assembly, so that more impurities and water molecules in the water are repeatedly electrolyzed in the electrode gap;
wherein a structure of the electrolysis electrode assembly and installation process conditions thereof have the features as follows: in a water electrolysis process, the water smoothly flows in the gap between the positive electrode and the negative electrode, so that the water electrolyzed in the gap between the positive electrode and the negative electrode is replaced and more impurities and water molecules are repeatedly electrolyzed by the positive electrode and the negative electrode; and probability and quantities of the impurities and the water molecules electrolyzed by the positive electrode and the negative electrode are increased, thereby increasing the electrolysis efficiency of the water.

2. The novel membrane-less water electrolysis method for obviously increasing electrolysis efficiency according to claim 1, wherein for the electrolysis electrode assembly, the gap between the positive and the negative electrodes of the electrolysis electrode assembly is smaller than or equal to 1 mm, thereby benefiting enhancement of the electrolysis of the impurities and the water molecules in the water and increase of the water electrolysis efficiency under a certain electrolysis power and a certain electrolysis electrode assembly structure.

3. The novel membrane-less water electrolysis method for obviously increasing electrolysis efficiency according to claim 1, wherein the electrolysis electrode assembly makes daily drinking water and daily water usage into electrolyzed reduced water with an oxidation-reduction potential of a negative value and a hydrogen content more than zero.

4. The novel membrane-less water electrolysis method for obviously increasing electrolysis efficiency according to claim 1, wherein structures of the positive and the negative electrodes in the electrolysis electrode assembly are designed as follows: when natural static water in the electrode gap is electrolyzed to produce fluidity, the water and ions in the electrode gap flow hereby, then more water flows through the gap between the positive and the negative electrodes, and the water electrolyzed in the gap is replaced, so that more impurities and water molecules in the water are repeatedly electrolyzed by current between the positive and the negative electrodes, and the probability and the quantities of the impurities and the water molecules electrolyzed by the positive and the negative electrodes are increased, thereby increasing the electrolysis efficiency of the water.

5. The novel membrane-less water electrolysis method for obviously increasing electrolysis efficiency according to claim 1, wherein for the electrolysis electrode assembly, a certain space is reserved outside at two ends of the electrode gap, so that the water smoothly flows in the gap between the positive and the negative electrodes while flowing in the electrolyzed process, thereby increasing the electrolysis efficiency of the water.

6. The novel membrane-less water electrolysis method for obviously increasing electrolysis efficiency according to claim 1, wherein for the electrolysis electrode assembly, time of electrolyzing the flowing water in the electrode gap is prolonged in a certain space occupied by the electrolysis electrode assembly by reasonably increasing the area of the electrode gap, so that more impurities and water molecules are repeatedly electrolyzed by the positive and the negative electrodes, and the probability and the quantities of the impurities and the water molecules electrolyzed by the positive and the negative electrodes are increased, thereby increasing the electrolysis efficiency of the water.

7. The novel membrane-less water electrolysis method for obviously increasing electrolysis efficiency according to claim 1, wherein for the electrolysis electrode assembly, a water outlet channel of the electrolysis electrode assembly is designed to be narrower than a water inlet channel to appropriately relieve flow velocity of water flowing into the gap of the electrolysis electrodes, so that more impurities and the water molecules are repeatedly electrolyzed by current between the positive and the negative electrodes, and the probability and the quantities of the impurities and the water molecules electrolyzed by the positive and the negative electrodes are increased, thereby increasing the electrolysis efficiency of the water.

8. The novel membrane-less water electrolysis method for obviously increasing electrolysis efficiency according to claim 1, wherein under a condition that a wall material and a shape of an electrolytic cell coating the electrolysis electrode assembly are suitable for serving as electrodes, the electrolysis electrode assembly is properly connected to serve as an electrolysis electrode, thereby increasing the area of the gap of the electrolysis electrode and increasing the electrolysis efficiency of the water.

9. The novel membrane-less water electrolysis method for obviously increasing electrolysis efficiency according to claim 1, wherein the electrolysis electrode assembly is composed of two electrodes of different polarities; one electrode has a shape of a cylindrical hole, a quantity of cylindrical electrodes is N, and N is equal to or more than 1; notches may not exist or may exist on cylindrical walls, and the cylindrical holed electrodes are mechanically fixed and mutually electrically connected with one another; the other electrode is cylindrical, various columns are mechanically fixed and mutually electrically connected with one another, a quantity of the columns of cylindrical electrodes is M, M is equal to or more than 1, and the columns are hollow or solid and may have or do not have notches; heights of the cylindrical electrodes and the cylindrical electrodes are not limited and are selected according to needs; the cylindrical electrodes and the cylindrical electrodes are correspondingly inserted, that is, each column of the cylindrical electrodes is inserted into each corresponding cylindrical hole, and a gap for electrolyzing the water is reserved between a surface of each correspondingly inserted cylindrical electrode and an opposite surface of each cylindrical holed electrode; the water in the electrode gap flows in an electrolysis operating process; and a certain space is reserved outside at two ends of the electrode gap, so that the water flows in the electrode gap in the electrolyzed process.

10. The novel membrane-less water electrolysis method for obviously increasing electrolysis efficiency according to claim 1, wherein the electrolysis electrode assembly is composed of two groups of cylindrical electrodes of different polarities, each group comprises N cylindrical electrodes, and N ranges from 1 to an arbitrary value; a position of each cylindrical electrode in each group is relatively fixed, the two groups of cylindrical electrodes can be mutually assembled in an inserted manner, and an electrode gap for electrolysis of water and an area of the gap are formed on opposite cylindrical surfaces of each pair of adjacent cylindrical electrodes of different polarities.

11. The novel membrane-less water electrolysis method for obviously increasing electrolysis efficiency according to claim 1, wherein for the electrolysis electrode assembly, a structure of one of the electrodes of different polarities has a shape of E, a structure of the other of the electrodes has a shape of E inverted in left and right, and the E-shaped electrode and the inverted E-shaped electrode form an arched electrode gap in a concave-convex insertion manner; and N E-shaped electrodes are stacked and inserted with N stacked inverted E-shaped electrodes in a concave-convex manner to form a plurality of connected arched electrode gaps and gap areas, and N ranges from 1 to an arbitrary value.

12. The novel membrane-less water electrolysis method for obviously increasing electrolysis efficiency according to claim 1, wherein the electrolysis electrode assembly is composed of two groups of N electrode plates of different polarities, and N ranges from 1 to an arbitrary value; and the two groups of electrode plates are mutually assembled in an inserted manner, and an electrode gap and a gap area are formed between opposite plate surfaces of each pair of adjacent electrode plates of different polarities.

13. The novel membrane-less water electrolysis method for obviously increasing electrolysis efficiency according to claim 1, wherein the electrolysis electrode assembly increases the electrolysis efficiency by adopting a design that the positive and the negative electrodes have unequal areas, and the unequal areas of the positive and the negative electrodes are reflected as follows: the area of the positive electrode is larger than the area of the negative electrode, or vice versa; and a horizontal projection of an electrode plate in a high-level position is equal to or smaller than a horizontal projection of an electrode plate in a low-level position, thereby increasing the electrolysis efficiency of the water.

14. The novel membrane-less water electrolysis method for obviously increasing electrolysis efficiency according to claim 1, wherein the electrodes of the electrolysis electrode assembly are activated carbon or ceramics or other electrodes capable of releasing trace substances in the process of water electrolysis, and can contribute to increasing the electrolysis efficiency of the water.
